(19) United States
(12) Patent Application Publication
(10) Pub. No.: US 2026/0147113 A1
(43) Pub. Date: May 28, 2026

(54) DATA PROCESSING APPARATUS, DATA PROCESSING METHOD, PROGRAM, AND DATA PROCESSING SYSTEM

(71) Applicant: Renesas Electronics Corporation, Tokyo (JP)

(72) Inventor: Hirohisa FURUKAWA, Tokyo (JP)

(21) Appl. No.: 19/357,206

(22) Filed: Oct. 14, 2025

(30) Foreign Application Priority Data
Nov. 22, 2024 (JP) 2024-204102

(51) Int. Cl. G01S 13/931

(52) U.S. Cl. CPC G01S 13/931

(57) ABSTRACT

The time required for processing measurement data is reduced. The data processing device, according to the present disclosure, acquires reception intensity data representing a reception intensity of signals reflected at measurement points located at distances from the target vehicle for each of multiple distances. It identifies a short-range measurement point that is within a first predetermined distance from the target vehicle. If the short-range measurement point meets predetermined data reduction conditions, it specifies the data corresponding to the distance within a second predetermined distance from the target vehicle, among data indicated in the reception intensity data, as the data to be analyzed.

### CROSS-REFERENCE TO RELATED APPLICATIONS

The disclosure of Japanese Patent Application No. 2024-204102 filed on Nov. 22, 2024, including the specification, drawings and abstract is incorporated herein by reference in its entirety.

### BACKGROUND

This disclosure relates to a data processing device, a data processing method, a program, and a data processing system.

There are disclosed techniques listed below.
[Patent Document 1] Japanese Unexamined Patent Application Publication No. 2016-048819

Technology for processing data obtained from distance sensors installed in vehicles has been developed. For example, Patent Document 1 discloses that a radar ECU (Electronic Control Unit) calculates the distance to an obstacle using data obtained from the radar and notifies the driving assistance ECU of the calculation result.

### SUMMARY

When the amount of measurement data obtained from the distance sensor is large, it takes time to process the measurement data. Patent Document 1 does not mention the time required for processing the measurement data.

A data processing device according to one embodiment specifies a short-range measurement point, which is a measurement point located within a first predetermined distance from the target vehicle, based on the reception intensity data representing the reception intensity of signals reflected at measurement points separated by distances from the target vehicle, respectively. Furthermore, the data processing device specifies data corresponding to a distance within a second predetermined distance from the target vehicle as data to be analyzed if the short-range measurement points satisfy a predetermined condition.

According to the above-mentioned embodiment, technology is provided that reduces the time required for processing measurement data.

### BRIEF DESCRIPTION OF THE DRAWINGS

FIG. 1 illustrates an overview of the operation of the data processing device.

FIG. 2 is a block diagram illustrating the functional configuration of the data processing device.

FIG. 3 is a block diagram illustrating the hardware configuration of a computer implementing the data processing device.

FIG. 4 is a flowchart illustrating the flow of processing executed by the data processing device.

FIG. 5 is a flowchart illustrating the flow of the analysis target specifying process that is repeatedly executed.

FIG. 6 is a diagram illustrating the functional configuration of a data processing device 2000 with an output unit.

### DETAILED DESCRIPTION

Below, embodiments of this disclosure will be described in detail with reference to the drawings. In each drawing, the same or corresponding elements are denoted by the same reference numerals, and repetitive descriptions are omitted as necessary for clarity. Unless specifically described otherwise, predetermined values such as threshold values are stored in advance in storage devices accessible by the device using those values. Furthermore, unless specifically described otherwise, the storage unit is composed of one or more arbitrary numbers of storage devices.

### Overview

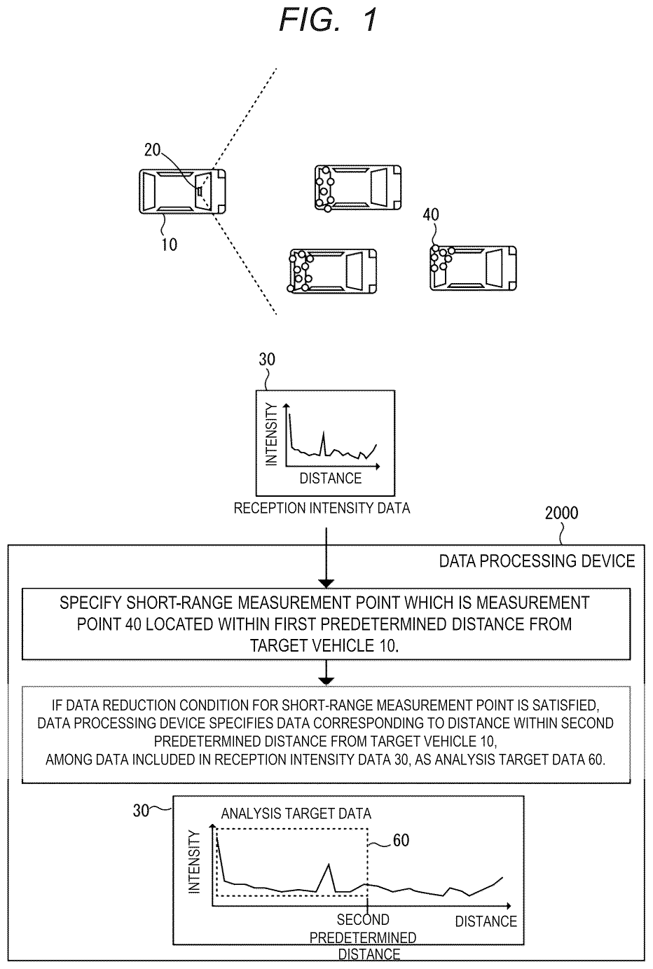

FIG. 1 illustrates an overview of the operation of the data processing device 2000. Here, FIG. 1 is a diagram to facilitate understanding of the overview of the data processing device 2000, and the operation of the data processing device 2000 is not limited to what is shown in FIG. 1.

The data processing device 2000 handles reception intensity data 30 obtained from the sensor 20. Sensor 20 is any sensor that performs distance measurement using signals. For example, the sensor 20 may be a millimeter-wave radar or LiDAR (Light Detection and Ranging).

The sensor 20 is installed on the target vehicle 10. The target vehicle 10 can be any vehicle such as an automobile or a motorcycle. The reception intensity data 30 obtained from the sensor 20 is used, for example, for controlling the target vehicle 10. In this case, the target vehicle 10 may be a fully autonomous vehicle that does not require driver operation, or a vehicle where some operations are assisted by a computer (e.g., ADAS (advanced driver-assistance systems)).

In FIG. 1, the sensor 20 is installed to face forward with respect to the target vehicle 10. However, the orientation of the sensor 20 is not limited to the front of the target vehicle 10 and can be in any direction. Additionally, if multiple distance sensors are installed on the target vehicle 10, the data processing device 2000 can treat each of those multiple distance sensors as the sensor 20.

The sensor 20 transmits signals and generates reception intensity data 30 by receiving the reflected signals. The signals transmitted by the sensor 20 are electromagnetic waves such as millimeter waves or lasers.

The reception intensity data 30 indicates the intensity of the received signals received by sensor 20, associated with each of multiple distances based on the sensor 20. The intensity of the received signal corresponding to a certain distance is the reception intensity of the signal reflected at a measurement point that is that certain distance away from the sensor 20. The measurement point is a point on an object that reflects the signal transmitted from the sensor 20. Here, since the sensor 20 is installed on the target vehicle 10, the “distance based on the sensor 20” can also be treated as the “distance based on the target vehicle 10.”

The data processing device 2000 operates as follows, for example. The data processing device 2000 acquires the reception intensity data 30. Furthermore, the data processing device 2000 specifies, among measurement points, a measurement point 40 located within a first predetermined distance from the target vehicle 10. The first predetermined distance is any predetermined distance. Hereinafter, measurement points 40 located within the first predetermined distance from the target vehicle 10 is also referred to as a “short-range measurement point.”

The data processing device 2000 determines whether a predetermined condition (hereinafter referred to as the data reduction condition) related to the short-range measurement point is satisfied. The data reduction condition is a condition that indicates, for example, that the number of short-range measurement points is relatively large. A condition indicating that the number of short-range measurement points is relatively large is, for example, a condition such as “he number of short-range measurement points is equal to or greater than a threshold” or “he ratio of the number of short-range measurement points to the total number of measurement points is equal to or greater than a threshold.”

If the data reduction condition is satisfied, the data processing device 2000 specifies data corresponding to a distance within a second predetermined distance from the target vehicle 10, among the data included in the reception intensity data 30, as the data to be analyzed (analysis target data 60). The first predetermined distance and the second predetermined distance may be the same distance or different distances. If the data reduction condition is not satisfied, for example, the data processing device 2000 specifies the entire reception intensity data 30 as the analysis target data 60.

Here, the data reduction condition is set to be satisfied when information about a position relatively far from the target vehicle 10 (a position farther than the second predetermined distance) is unnecessary. If information about a position farther than the second predetermined distance from the target vehicle 10 is unnecessary, data corresponding to a distance farther than the second predetermined distance from the target vehicle 10 included in the reception intensity data 30 is unnecessary. Therefore, if the data reduction condition is satisfied, the data processing device 2000 does not treat data corresponding to a distance farther than the predetermined distance from the target vehicle 10 as analysis target data 60.

Specific situations where information about a position relatively far from the target vehicle 10 is unnecessary vary. For example, such a situation is when there is a traffic jam in the forward direction of the sensor 20 (e.g., the traveling direction of the target vehicle 10). In the case of a traffic jam, since the target vehicle 10 moves at a low speed, the probability that an object located relatively far from the target vehicle 10 will affect the target vehicle 10 is low. Therefore, information about a position relatively far from the target vehicle 10 is unnecessary.

Another situation where information about a position relatively far from the target vehicle 10 is unnecessary is when there is a wall in the forward direction of sensor 20. In this case, the probability that an object located farther than this wall will affect the target vehicle 10 is low. Therefore, information about a position farther than this wall is unnecessary.

Another situation where information about a position relatively far from the target vehicle 10 is unnecessary is when a railroad crossing in the forward direction of the sensor 20 is closed. If the railroad crossing is closed, the probability that an object located beyond the railroad crossing will affect the target vehicle 10 is low. Therefore, information about a position farther than this railroad crossing is unnecessary.

### Example of Effects

According to the data processing device 2000, a short-range measurement point, which is a measurement point 40 located within a first predetermined distance from the target vehicle 10, is specified using the reception intensity data 30. Then, if the data reduction condition related to the short-range measurement point is satisfied, data corresponding to a distance within a second predetermined distance from the target vehicle 10 is specified as the analysis target data 60.

As described above, the data reduction condition is set to be satisfied when information about a position farther than the second predetermined distance from the target vehicle 10 is unnecessary. By doing so, when information about a position farther than the second predetermined distance from the target vehicle 10 is unnecessary, data corresponding to a distance farther than the second predetermined distance from the target vehicle 10 is not treated as analysis target data 60. This allows the amount of data in the analysis target data 60 to be reduced.

The analysis target data 60 is used, for example, for controlling the target vehicle 10. By reducing the amount of data in the analysis target data 60, the time required for controlling the target vehicle 10 can be shortened. Additionally, by reducing the amount of data in the analysis target data 60, the amount of computational resources required for controlling the target vehicle 10 can also be reduced.

Below, the data processing device 2000 of this embodiment will be described in more detail.

### Example of Functional Configuration

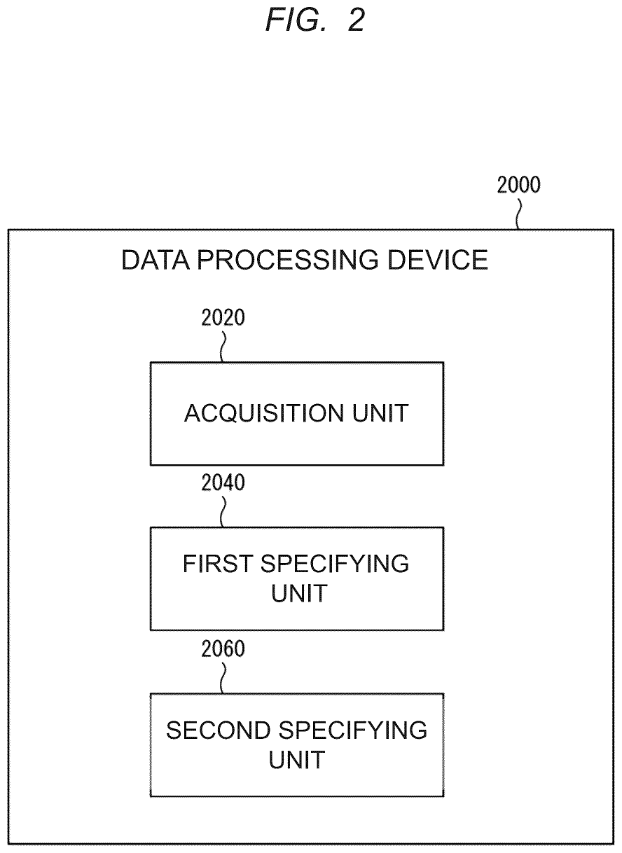

FIG. 2 is a block diagram illustrating the functional configuration of the data processing device 2000. The data processing device 2000 includes an acquisition unit 2020, a first specifying unit 2040, and a second specifying unit 2060. The acquisition unit 2020 acquires the reception intensity data 30. The first specifying unit 2040 specifies the short-range measurement point. The second specific section 2060 identifies data corresponding to a distance within a second predetermined range from the data included in the received intensity data 30 as analysis target data 60, when the data reduction condition related to the short-range measurement point is satisfied.

### Example of Hardware Configuration

Each functional component of the data processing device 2000 may be implemented using hardware (e.g., hardwired electronic circuits) or a combination of hardware and software (e.g., a combination of electronic circuits and programs controlling them). Below, further explanation is provided for the case where each functional component of the data processing device 2000 is implemented using a combination of hardware and software.

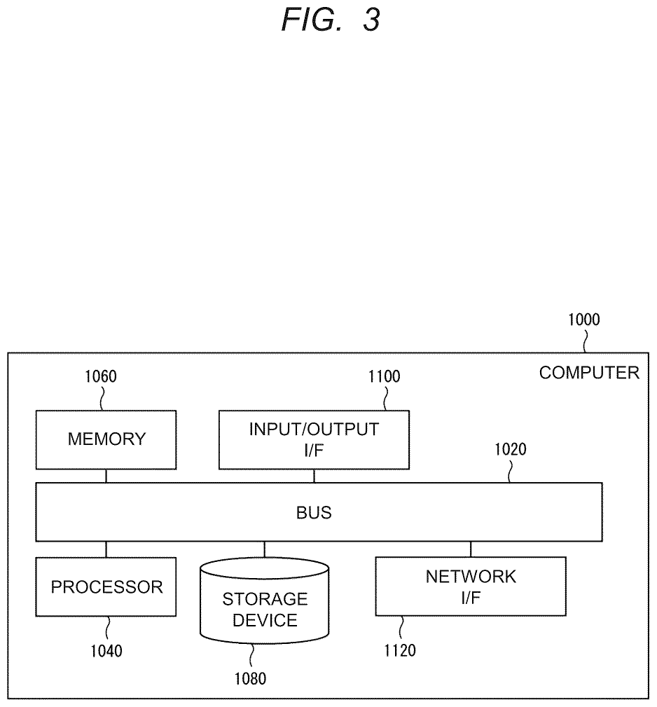

FIG. 3 is a block diagram illustrating the hardware configuration of a computer 1000 that implements the data processing device 2000. The computer 1000 can be any computer. For example, the computer 1000 may be an ECU (Electronic Control Unit) installed inside the target vehicle 10. This ECU is implemented using an MCU (Micro Controller Unit) such as a SoC (System on Chip). It should be noted that the computer 1000 may be an MCU rather than the entire ECU. The computer 1000 may be a dedicated computer designed to implement the data processing device 2000 or a general-purpose computer.

For example, by installing a predetermined application on the computer 1000, each function of the data processing device 2000 is realized on the computer 1000. The aforementioned application consists of a program to realize each functional component of the data processing device 2000.

The method of obtaining the above program is arbitrary. For example, the program can be obtained from a storage medium where it is stored. The storage medium in which the program is stored can be any storage medium such as a DVD (Digital Versatile Disk) or USB (Universal Serial Bus) memory. Additionally, for example, the program can be obtained by downloading it from a server device that manages the storage device where the program is stored.

The computer 1000 includes a bus 1020, a processor 1040, a memory 1060, a storage device 1080, an input/output interface (I/F) 1100, and a network interface 1120. The bus 1020 is a data transmission path for the processor 1040, memory 1060, storage device 1080, input/output interface 1100, and network interface 1120 to send and receive data with each other. However, the method of connecting the processor 1040 and others is not limited to bus connections.

The processor 1040 is a variety of processors such as an MPU (Microprocessor Unit), CPU (Central Processing Unit), GPU (Graphics Processing Unit), or FPGA (Field-Programmable Gate Array). The memory 1060 is a main storage device realized using RAM (Random Access Memory) or the like. The storage device 1080 is an auxiliary storage device realized using ROM (Read Only Memory), flash memory, or memory cards.

The input/output interface 1100 is an interface for connecting the computer 1000 to input/output devices. For example, a sensor 20 is connected to the input/output interface 1100.

The network interface 1120 is an interface for connecting the computer 1000 to a network. This network is, for example, Ethernet (registered trademark) or CAN (Controller Area Network).

The storage device 1080 stores the program to realize each functional component of the data processing device 2000 (the program to realize the aforementioned application). The processor 1040 realizes each functional component of the data processing device 2000 by reading this program in memory 1060 and executing this program.

The data processing device 2000 may be realized by a single computer 1000 or by multiple computers 1000. In the latter case, the configuration of each computer, 1000, does not need to be the same and can be different.

### Flow of Processing

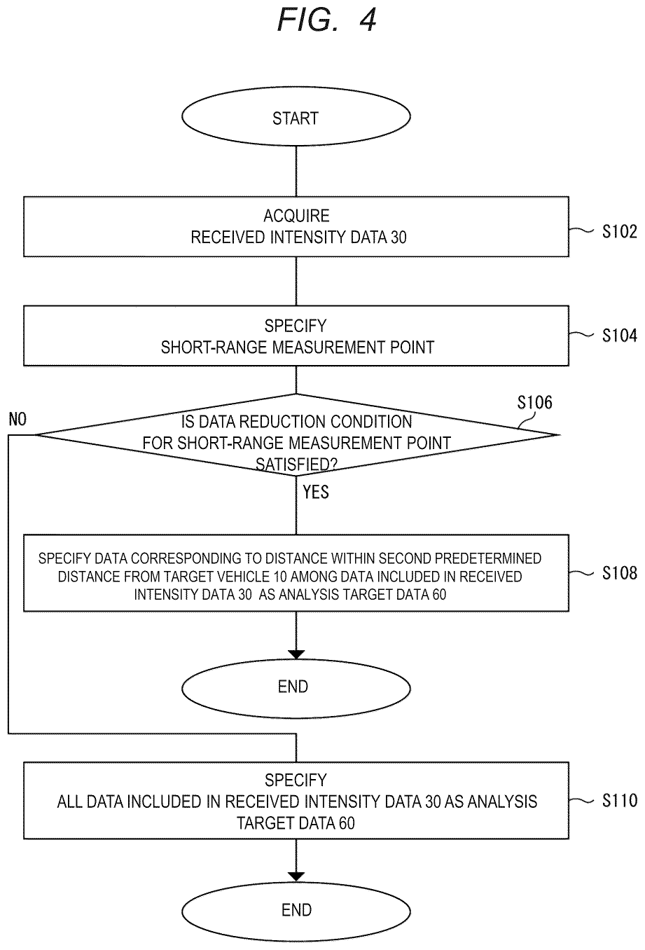

FIG. 4 is a flowchart illustrating the flow of processing executed by the data processing device 2000. The acquisition unit 2020 acquires the received intensity data 30 (S102). The first specifying unit 2040 specifies a short-range measurement point (S104). The second specifying unit 2060, if the data reduction condition for the short-range measurement point is satisfied (S106: YES), specifies the data corresponding to the distance within the second predetermined distance among the data included in the received intensity data 30 as the analysis target data 60 (S108). On the other hand, if the data reduction condition is not satisfied (S106: NO), the second specifying unit 2060 specifies all the data included in the received intensity data 30 as the analysis target data 60 (S110).

The data processing device 2000 can repeatedly execute the series of processes shown in FIG. 4. For example, the sensor 20 repeatedly generates the received intensity data 30. The data processing device 2000 sequentially acquires the repeatedly generated received intensity data 30 and specifies the analysis target data 60 for each received intensity data 30.

### Acquisition of Received Intensity Data 30: S102

The acquisition unit 2020 acquires the received intensity data 30 (S102). The method by which the acquisition unit 2020 acquires the received intensity data 30 varies. For example, the sensor 20 is configured to output the received intensity data 30 to the data processing device 2000. In this case, the acquisition unit 2020 acquires the received intensity data 30 by receiving the received intensity data 30 output from the sensor 20.

Additionally, for example, the sensor 20 is configured to store the received intensity data 30 in a storage unit accessible from the data processing device 2000. In this case, the acquisition unit 2020 acquires the received intensity data 30 by reading it from the storage unit.

The sensor 20 repeatedly generates the received intensity data 30. Specifically, the sensor 20 generates the received intensity data 30 at a predetermined measurement interval. Therefore, for example, the acquisition unit 2020 acquires the received intensity data 30 at the predetermined measurement interval.

The sensor 20 may have multiple transmission antennas for transmitting ranging signals and multiple reception antennas for receiving reflected signals. In this case, sensor 20 generates the received intensity data 30 for each combination of the transmission and reception antennas. Therefore, the acquisition unit 2020 acquires these multiple received intensity data 30.

For example, suppose there are four transmission antennas and four reception antennas each. In this case, there are 16 combinations of transmission and reception antennas. Therefore, the sensor 20 generates 16 received intensity data 30. The acquisition unit 2020 receives these 16 received intensity data 30.

### Specification of Short-Range Measurement Point: S104

The first specifying unit 2040 specifies a short-range measurement point (S104). For this purpose, for example, the first specifying unit 2040 generates point cloud data regarding the position of each measurement point. Point cloud data is a collection of multiple point data. One point data indicates, for example, the position of one measurement point and the distance from the sensor 20 to the measurement point. The position of the measurement point may be represented in two dimensions or three dimensions.

Here, if the position of each measurement point is not used by the data processing device 2000, the point data does not need to indicate the position of the measurement point. Also, as will be described later, there may be cases where the speed of each measurement point is used by the second specifying unit 2060. In this case, it is preferable that each point data further indicates the speed of the corresponding measurement point.

For example, the first specifying unit 2040 generates point cloud data for a certain measurement time using multiple received intensity data 30 generated at that measurement time. Note that various existing methods can be used to generate point cloud data that indicates the distance to each measurement point, the position of each measurement point, and the speed of each measurement point using multiple data indicating the intensity of the received signal for each distance.

The first specifying unit 2040 determines whether the distance from the target vehicle 10 to each of the multiple point data included in the point cloud data is within the first predetermined distance. The point data with a distance from the target vehicle 10 within the first predetermined distance represents a short-range measurement point. Therefore, the first specifying unit 2040 specifies the measurement point represented by the point data with a distance from the target vehicle 10 within the first predetermined distance as a short-range measurement point.

The point cloud data may be generated using a part of the received intensity data 30. By generating point cloud data from a part of the received intensity data 30 instead of the entire received intensity data 30, the time and computational resources required to generate the point cloud data can be reduced. Hereinafter, point cloud data generated using a part of the received intensity data 30 is referred to as second point cloud data. On the other hand, point cloud data generated using the entire received intensity data 30 is referred to as first point cloud data.

For example, as described above, the data processing device 2000 repeatedly executes a series of processes (hereinafter referred to as analysis target specifying process) to specify the analysis target data 60 from the received intensity data 30. In the n th time analysis target specifying process, the first specifying unit 2040 determines whether the data reduction condition was satisfied in the previous (i.e., n−1 th time) analysis target specifying process. Then, depending on the result of the determination, either the first point cloud data or the second point cloud data are generated.

More specifically, if the data reduction condition was not met in the previous analysis target identification process, the first specifying unit 2040 generates the first point cloud data using the entire received intensity data 30. On the other hand, if the data reduction condition was met in the previous analysis target identification process, the first specifying unit 2040 generates the second point cloud data using a part of the received intensity data 30. For example, the second point cloud data is generated using data corresponding to a distance within a second predetermined distance from the target vehicle 10 in the received intensity data 30.

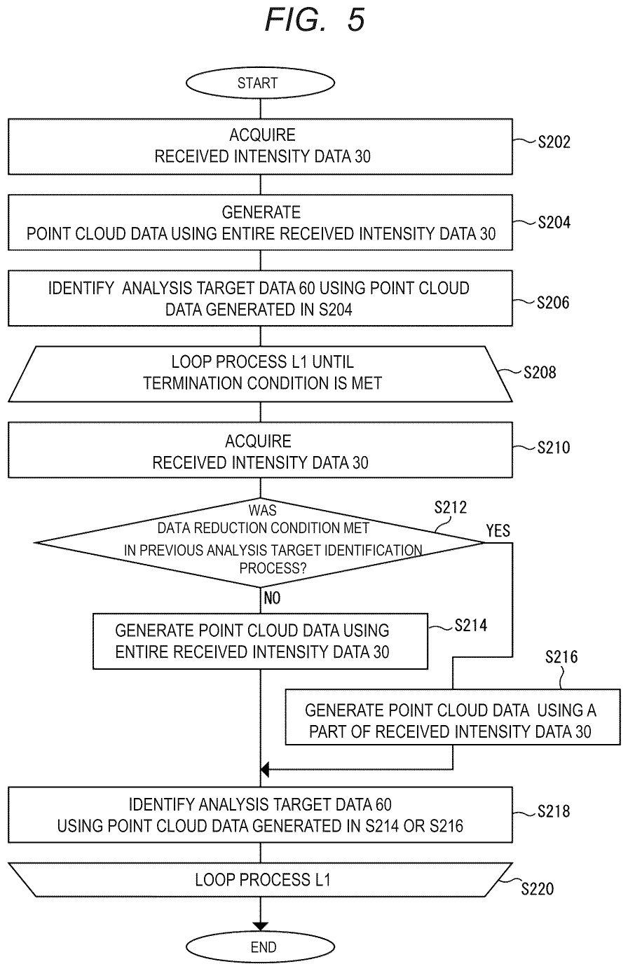

FIG. 5 is a flowchart illustrating the flow of the analysis target identification process that is repeatedly executed. Steps S202 to S206 represent the first execution of the analysis target identification process. In the first execution, the analysis target data 60 has not yet been identified. Therefore, the first point cloud data generated from the entire received intensity data 30 is used.

Specifically, the acquisition unit 2020 acquires the received intensity data 30 (S202). The first specifying unit 2040 generates the first point cloud data using the entire received intensity data 30 (S204). The data processing device 2000 identifies the analysis target data 60 from the received intensity data 30 acquired in S202 using the first point cloud data (S206).

Steps S208 to S220 constitute loop process L1. Loop process L1 represents the second and subsequent executions of the analysis target identification process.

In S208, the data processing device 2000 determines whether a predetermined termination condition is met. If the termination condition is met, the execution of loop process L1 ends. That is, the execution of the series of processes shown in FIG. 5 ends.

Any condition can be set as the termination condition. For example, the termination condition could be “n operation to restart or shut down the data processing device 2000 has been performed.”

If the termination condition is not met in S208, the acquisition unit 2020 acquires the received intensity data 30 (S210). The first specifying unit 2040 determines whether the data reduction condition was met in the previous analysis target identification process (S212). If the data reduction condition was not met (S212: NO), the first specifying unit 2040 generates the first point cloud data using the entire received intensity data 30 (S214). If the data reduction condition was met (S212: YES), the first specifying unit 2040 generates the second point cloud data using a part of the received intensity data 30 (S216). The data processing device 2000 identifies the analysis target data 60 from the received intensity data 30 using the first point cloud data generated in S214 or the second point cloud data generated in S216 (S218). Since S220 is the end of loop process L1, S208 is executed again.

### Determination of Whether the Data Reduction Condition is Met: S106

The second specifying unit 2060 determines whether the data reduction condition related to the short-range measurement points is met (S106). As mentioned above, the data reduction condition is set to be met when information regarding a position farther than the second predetermined distance from the target vehicle 10 is unnecessary. Therefore, for example, a condition representing “relatively large number of short-range measurement points” is used as the data reduction condition. As mentioned above, specific examples of the condition representing “relatively large number of short-range measurement points” include “the number of short-range measurement points is equal to or greater than a predetermined number” or “the ratio of the number of short-range measurement points to the total number of measurement points is equal to or greater than a predetermined ratio.”

For example, suppose the data reduction condition is “he number of short-range measurement points is equal to or greater than a predetermined number.” In this case, the second specifying unit 2060 determines whether the number of short-range measurement points is equal to or greater than the predetermined number. If the number of short-range measurement points is equal to or greater than the predetermined number, the second specifying unit 2060 determines that the data reduction condition is met. On the other hand, if the number of short-range measurement points is not equal to or greater than the predetermined number, the second specifying unit 2060 determines that the data reduction condition is not met.

Additionally, for example, suppose the data reduction condition is “the ratio of the number of short-range measurement points to the total number of measurement points is equal to or greater than a predetermined ratio.” If the ratio of the number of short-range measurement points to the total number of measurement points is equal to or greater than the predetermined ratio, the second specifying unit 2060 determines that the data reduction condition is met. On the other hand, if the ratio of the number of short-range measurement points to the total number of measurement points is not equal to or greater than the predetermined ratio, the second specifying unit 2060 determines that the data reduction condition is not met. Here, the total number of measurement points can be represented by the total number of point data included in the point cloud data.

The data reduction condition may also include conditions related to the speed of the measurement points. For example, a condition representing “relatively large number of short-range measurement points with a speed equal to or less than a predetermined speed” is used as the data reduction condition.

The condition “a relatively large number of short-range measurement points with a speed equal to or less than a predetermined speed” is met when there are many measurement points near the target vehicle 10 that are not moving or are moving at a low speed. Therefore, by including conditions related to the speed of the measurement points in the data reduction condition, it is possible to more accurately grasp situations such as traffic congestion occurring in the forward direction of the sensor 20 or the presence of a wall in the forward direction of the sensor 20.

The condition “relatively large number of short-range measurement points with a speed equal to or less than a predetermined speed” can be more specifically expressed as “the number of short-range measurement points with a speed equal to or less than a predetermined speed is equal to or greater than a predetermined number” or “the ratio of the number of short-range measurement points with a speed equal to or less than a predetermined speed to the total number of measurement points is equal to or greater than a predetermined ratio.” For example, suppose the data reduction condition is “the number of short-range measurement points with a speed equal to or less than a predetermined speed is equal to or greater than a predetermined number.” In this case, the second specifying unit 2060 determines whether the number of short-range measurement points with a speed equal to or less than a predetermined speed is equal to or greater than the predetermined number.

If the number of short-range measurement points with a speed equal to or less than a predetermined speed is equal to or greater than the predetermined number, the second specifying unit 2060 determines that the data reduction condition is met. On the other hand, if the number of short-range measurement points with a speed equal to or less than a predetermined speed is not equal to or greater than the predetermined number, the second specifying unit 2060 determines that the data reduction condition is not met.

Suppose the data reduction condition is “the ratio of the number of short-range measurement points with a speed equal to or less than a predetermined speed to the total number of measurement points is equal to or greater than a predetermined ratio.” In this case, the second specifying unit 2060 determines whether the ratio of the number of short-range measurement points with a speed equal to or less than a predetermined speed to the total number of measurement points is equal to or greater than the predetermined ratio.

If the ratio of the number of short-range measurement points with a speed equal to or less than a predetermined speed to the total number of measurement points is equal to or greater than the predetermined ratio, the second specifying unit 2060 determines that the data reduction condition is met. On the other hand, if the ratio of the number of short-range measurement points with a speed equal to or less than a predetermined speed to the total number of measurement points is not equal to or greater than the predetermined ratio, the second specifying unit 2060 determines that the data reduction condition is not met.

To identify short-range measurement points with a speed equal to or less than a predetermined speed, the first specifying unit 2040 determines for each point data included in the point cloud data whether the distance from the target vehicle 10 is equal to or less than a first predetermined distance and whether the speed is equal to or less than a predetermined speed. The determination of whether the distance from the target vehicle 10 is equal to or less than a first predetermined distance and the determination of whether the speed is equal to or less than a predetermined speed can be performed in any order.

The data reduction conditions may further include conditions related to the spatial range of the measurement points of interest. For example, a condition representing “relatively large number of measurement points located within a first predetermined distance from the target vehicle 10 and included in a predetermined spatial range” is used as the data reduction condition. By focusing on measurement points included in a specific spatial range in this way, it is possible to consider the density of measurement points.

The spatial range can be defined by one or more ranges in the coordinate space of the point data, such as the range in the X-axis direction, the range in the Y-axis direction, and the range in the Z-axis direction. For example, the range in the X-axis direction and the range in the Y-axis direction can be defined by the condition “x1<=X<=x2 and y1<=Y<=y2.”

Suppose the condition related to the spatial range of the measurement points of interest is included in the data reduction condition. In this case, the first specifying unit 2040 identifies point data included in the predetermined spatial range indicated by the data reduction condition from the point cloud data generated from the received intensity data 30 or the analysis target data 60. Then, the first specifying unit 2040 determines whether the identified point data corresponds to short-range measurement points.

Both the spatial range condition and the speed condition may be included in the data reduction condition. For example, a data reduction condition representing “relatively large number of short-range measurement points located within a predetermined spatial range and having a speed equal to or less than a predetermined speed” is used. In this case, the first specifying unit 2040 identifies short-range measurement points with a speed equal to or less than a predetermined speed from within the predetermined spatial range.

### Handling of Analysis Target Data 60

The handling of analysis target data 60 varies. For example, data processing device 2000 outputs the analysis target data 60. If the data reduction condition is met, data indicating the reception intensity for each distance within a second predetermined distance from the target vehicle 10 is output as the analysis target data 60. On the other hand, if the data reduction condition is not met, the entire reception intensity data 30 is output as the analysis target data 60.

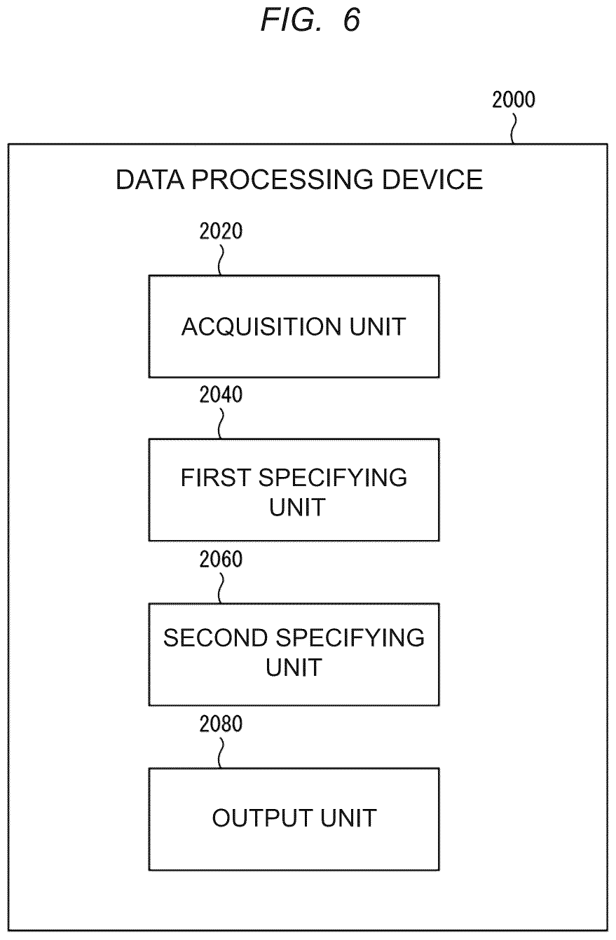

The functional configuration unit that outputs the analysis target data 60 is called the output unit. FIG. 6 illustrates the functional configuration of the data processing device 2000 with the output unit 2080. The output unit 2080 outputs the analysis target data 60.

The output mode of the analysis target data 60 is arbitrary. For example, the output unit stores the analysis target data 60 in any storage unit. Additionally, for example, the output unit transmits the analysis target data 60 to a device that utilizes the analysis target data 60.

The output unit 2080 may output point cloud data generated from the analysis target data 60, in addition to or instead of the analysis target data 60 specified by the second specifying unit 2060. For example, the data processing device 2000 specifies the analysis target data 60 for each of the multiple reception intensity data 30 obtained from multiple combinations of transmission and reception antennas. This results in multiple analysis target data 60. The output unit 2080 generates point cloud data using these multiple analysis target data 60. Since the point cloud data generated from the analysis target data 60 is generated from the analysis target data 60, it includes point data for only some measurement points, not all measurement points. The output unit 2080 then outputs the point cloud data generated from the analysis target data 60. The output mode of the point cloud data generated from the analysis target data 60 is arbitrary, similar to the output mode of the analysis target data 60.

If the data reduction condition is not met, the output unit 2080 may output the first point cloud data.

Although the invention made by the present inventor has been specifically described based on the embodiment, the present invention is not limited to the described embodiment, and it is needless to say that various modifications can be made without departing from the gist thereof.

Each drawing is merely illustrative for explaining one or more embodiments. Each drawing is not necessarily associated with only one specific embodiment but may be associated with one or more other embodiments. As understood by those skilled in art, various features or steps described with reference to anyone drawing can be combined with features or steps shown in one or more other drawings to create e.g. embodiments not explicitly illustrated or described. Not all features or steps shown in anyone's drawing are necessarily essential, and some features or steps may be omitted. The order of steps described in any drawing may be changed as appropriate.

In this disclosure, the program includes a set of instructions (or software code) that, when loaded into a computer, causes the computer to perform one or more functions described in the embodiments. The program may be stored on non-transitory computer-readable media or tangible storage media. By way of example and not limitation, the computer-readable media or tangible storage media may include random-access memory (RAM), read-only memory (ROM), flash memory, solid-state drive (SSD), or other memory technologies, CD-ROM, digital versatile disc (DVD), Blu-ray™ disc, or other optical disc storage, magnetic cassette, magnetic tape, magnetic disk storage, or other magnetic storage devices. The program may also be transmitted over transitory computer-readable media or communication media. By way of example and not limitation, transitory computer-readable media or communication media may include electrical, optical, acoustic, or other forms of propagated signals.

### Additional Statement

### Additional Statement 1

A data processing device comprising:
an acquisition unit that acquires reception intensity data representing a reception intensity of signals reflected at measurement points at distances from the target vehicle for each of multiple distances;
a first specifying unit that specifies a short-range measurement point, which is a measurement point located within a first predetermined distance from the target vehicle; and
a second specifying unit that, when the short-range measurement points satisfy a predetermined data reduction condition, specifies data corresponding to a distance within a second predetermined distance from the target vehicle, among the data indicated by the reception intensity data, as data to be analyzed.

### Additional Statement 2

The data processing device according to Additional Statement 1, wherein the data reduction condition includes a condition that the number of short-range measurement points is equal to or greater than a predetermined number, or a condition that the ratio of the number of short-range measurement points to the total number of measurement points is equal to or greater than a predetermined ratio, and
wherein the second specifying unit determines whether the number of short-range measurement points is equal to or greater than the predetermined number, or whether the ratio of the number of short-range measurement points to the total number of measurement points is equal to or greater than the predetermined ratio.

### Additional Statement 3

The data processing device according to Additional Statement 2,
wherein the first specifying unit generates, using the reception intensity data, point cloud data in which point data indicating a distance from the measurement point to the target vehicle are included for each of multiple measurement points, and
wherein the first specifying unit specifies the short-range measurement point by identifying the point data indicating a distance equal to or less than the first predetermined distance from the point cloud data.

### Additional Statement 4

The data processing device according to Additional Statement 1,
wherein the data reduction condition includes a condition that the number of short-range measurement points with a speed equal to or less than a predetermined speed is equal to or greater than a predetermined number, or a condition that the ratio of the number of short-range measurement points with a speed equal to or less than the predetermined speed to the total number of measurement points is equal to or greater than a predetermined ratio,
wherein the first specifying unit further specifies the speed of each measurement point, and
wherein the second specifying unit determines whether the number of short-range measurement points with a speed equal to or less than the predetermined speed is equal to or greater than the predetermined number, or whether the ratio of the number of short-range measurement points with a speed equal to or less than the predetermined speed to the total number of measurement points is equal to or greater than the predetermined ratio.

### Additional Statement 5

The data processing device according to Additional Statement 4,
wherein the first specifying unit generates, using the reception intensity data, point cloud data in which point data indicating a distance from the measurement point to the target vehicle and the speed of the measurement point are included for each of multiple measurement points, and
wherein the first specifying unit specifies the short-range measurement point with a speed equal to or less than the predetermined speed by identifying the point data indicating a distance equal to or less than the first predetermined distance and a speed equal to or less than the predetermined speed from the point cloud data.

### Additional Statement 6

The data processing device according to Additional Statement 1,
wherein the data reduction condition includes a condition that the number of short-range measurement points included in a predetermined spatial range is equal to or greater than a predetermined number, or a condition that the ratio of the number of short-range measurement points included in the predetermined spatial range to the total number of measurement points is equal to or greater than a predetermined ratio, and
wherein the second specifying unit determines whether the number of short-range measurement points included in the predetermined spatial range is equal to or greater than the predetermined number, or whether the ratio of the number of short-range measurement points included in the predetermined spatial range to the total number of measurement points is equal to or greater than the predetermined ratio.

### Additional Statement 7

The data processing device according to Additional Statement 6,
wherein the first specifying unit generates, using the reception intensity data, point cloud data in which point data indicating a distance from the measurement point to the target vehicle and the position of the measurement point are included for each of multiple measurement points, and
the first specifying unit specifies the short-range measurement point included in the predetermined spatial range by identifying the point data indicating a position within the predetermined spatial range and a distance equal to or less than the first predetermined distance from the point cloud data.

### Additional Statement 8

The data processing device according to Additional Statement 1, having an output unit that outputs, using the data to be analyzed, point cloud data indicating the position of each measurement point located within the second predetermined distance from the target vehicle.

### Additional Statement 9

A data processing method executed by a computer, comprising:
acquiring reception intensity data representing a reception intensity of signals reflected at measurement points at distances from the target vehicle for each of multiple distances;
first specifying of specifying a short-range measurement point, which is a measurement point located within a first predetermined distance from the target vehicle; and
a second specifying of specifying data corresponding to a distance within a second predetermined distance from the target vehicle, among the data indicated by the reception intensity data, as data to be analyzed when the short-range measurement points satisfy a predetermined data reduction condition.

### Additional Statement 10

A program that causes a computer to execute:
acquiring reception intensity data representing a reception intensity of signals reflected at measurement points at distances from the target vehicle for each of multiple distances;
first specifying of specifying a short-range measurement point, which is a measurement point located within a first predetermined distance from the target vehicle; and
a second specifying of specifying data corresponding to a distance within a second predetermined distance from the target vehicle, among the data indicated by the reception intensity data, as data to be analyzed when the short-range measurement points satisfy a predetermined data reduction condition.

### Additional Statement 11

A data processing system comprising:
a sensor that generates reception intensity data representing a reception intensity of signals reflected at measurement points at distances from the target vehicle for each of multiple distances; and
a data processing device,
wherein the data processing device comprises:
an acquisition unit that acquires the reception intensity data;
a first specifying unit that specifies a short-range measurement point, which is a measurement point located within a first predetermined distance from the target vehicle; and
a second specifying unit that specifies data corresponding to a distance within a second predetermined distance from the target vehicle, among the data indicated by the reception intensity data, as data to be analyzed when the short-range measurement points satisfy a predetermined data reduction condition.

### Additional Statement 12

A data processing device comprising:
one or more storage elements in which instructions are stored; and
one or more processors,
wherein the one or more processors, by executing the instructions,
acquire reception intensity data representing a reception intensity of signals reflected at measurement points at distances from the target vehicle for each of multiple distances,
specify a short-range measurement point, which is a measurement point located within a first predetermined distance from the target vehicle, and
specify data corresponding to a distance within a second predetermined distance from the target vehicle, among the data indicated by the reception intensity data, as data to be analyzed when the short-range measurement points satisfy a predetermined data reduction condition.

### Additional Statement 13

A non-transitory computer-readable medium in which a program is stored that causes a computer to execute:
acquiring reception intensity data representing a reception intensity of signals reflected at measurement points at distances from the target vehicle for each of multiple distances;
first specifying of specifying a short-range measurement point, which is a measurement point located within a first predetermined distance from the target vehicle; and
second specifying of specifying data corresponding to a distance within a second predetermined distance from the target vehicle, among the data indicated by the reception intensity data, as data to be analyzed when the short-range measurement points satisfy a predetermined data reduction condition.

Some or all of the elements (e.g., configuration and function) described in Additional Statements 2 to 8, which are dependent on Additional Statement 1, may also be dependent on each of Additional Statements 9 to 13 in a similar dependent relationship to Additional Statements 2 to 8. Some or all of the elements described in any additional statement may be applicable to various hardware, software, recording units for recording software, systems, and methods.

What is claimed is:

1. A data processing device comprising:
an acquisition unit that acquires reception intensity data representing a reception intensity of signals reflected at measurement points located at distances from a target vehicle for each of multiple distances;
a first specifying unit that identifies a short-range measurement point, which is a measurement point located within a first predetermined distance from the target vehicle; and
a second specifying unit that, when the short-range measurement points satisfy a predetermined data reduction condition, identifies data corresponding to a distance within a second predetermined distance from the target vehicle, among the data indicated by the reception intensity data, as data to be analyzed.

2. The data processing device according to claim 1, wherein
the data reduction condition includes a condition that the number of short-range measurement points is equal to or greater than a predetermined number, or a condition that the ratio of the number of short-range measurement points to the total number of measurement points is equal to or greater than a predetermined ratio, and
the second specifying unit determines whether the number of short-range measurement points is equal to or greater than the predetermined number, or whether the ratio of the number of short-range measurement points to the total number of measurement points is equal to or greater than the predetermined ratio.

3. The data processing device according to claim 2,
wherein the first specifying unit generates, using the reception intensity data, point cloud data in which point data indicating a distance from the measurement point to the target vehicle are included for each of multiple measurement points, and
wherein the first specifying unit identifies the short-range measurement point by identifying the point data indicating a distance equal to or less than the first predetermined distance from the point cloud data.

4. The data processing device according to claim 1,
wherein the data reduction condition includes a condition that the number of short-range measurement points at a speed equal to or less than a predetermined speed is equal to or greater than a predetermined number, or a condition that the ratio of the number of short-range measurement points at a speed equal to or less than the predetermined speed to the total number of measurement points is equal to or greater than a predetermined ratio,
wherein the first specifying unit further identifies the speed of each measurement point, and
wherein the second specifying unit determines whether the number of short-range measurement points at a speed equal to or less than the predetermined speed is equal to or greater than the predetermined number, or whether the ratio of the number of short-range measurement points at a speed equal to or less than the predetermined speed to the total number of measurement points is equal to or greater than the predetermined ratio.

5. The data processing device according to claim 4,
wherein the first specifying unit generates, using the reception intensity data, point cloud data in which point data indicating a distance from the measurement point to the target vehicle and the speed of the measurement point are included for each of multiple measurement points, and
wherein the first specifying unit identifies the short-range measurement point at a speed equal to or less than the predetermined speed by identifying the point data indicating a distance equal to or less than the first predetermined distance and a speed equal to or less than the predetermined speed from the point cloud data.

6. The data processing device according to claim 1,
wherein the data reduction condition includes a condition that the number of short-range measurement points included in a predetermined spatial range is equal to or greater than a predetermined number, or a condition that the ratio of the number of short-range measurement points included in the predetermined spatial range to the total number of measurement points is equal to or greater than a predetermined ratio, and
wherein the second specifying unit determines whether the number of short-range measurement points included in the predetermined spatial range is equal to or greater than the predetermined number, or whether the ratio of the number of short-range measurement points included in the predetermined spatial range to the total number of measurement points is equal to or greater than the predetermined ratio.

7. The data processing device according to claim 6,
wherein the first specifying unit generates, using the reception intensity data, point cloud data in which point data indicating a distance from the measurement point to the target vehicle and the position of the measurement point are included for each of multiple measurement points, and
the first specifying unit identifies the short-range measurement point included in the predetermined spatial range by identifying the point data indicating a position within the predetermined spatial range and a distance equal to or less than the first predetermined distance from the point cloud data.

8. The data processing device according to claim 1, comprising an output unit that outputs, using the data to be analyzed, point cloud data indicating the position of each measurement point located within the second predetermined distance from the target vehicle.

9. A data processing method executed by a computer, comprising:
acquiring reception intensity data representing a reception intensity of signals reflected at measurement points located at distances from a target vehicle for each of multiple distances;
first identification of identifying a short-range measurement point, which is a measurement point located within a first predetermined distance from the target vehicle; and
a second identification of identifying data corresponding to a distance within a second predetermined distance from the target vehicle, among the data indicated by the reception intensity data, as data to be analyzed when the short-range measurement points satisfy a predetermined data reduction condition.

10. A program that causes a computer to execute:
acquiring reception intensity data representing a reception intensity of signals reflected at measurement points located at distances from a target vehicle for each of multiple distances;
first identification of identifying a short-range measurement point, which is a measurement point located within a first predetermined distance from the target vehicle; and
second identification of identifying data corresponding to a distance within a second predetermined distance from the target vehicle, among the data indicated by the reception intensity data, as data to be analyzed when the short-range measurement points satisfy a predetermined data reduction condition.

11. A data processing system comprising:
a sensor that generates reception intensity data representing a reception intensity of signals reflected at measurement points located at distances from a target vehicle for each of multiple distances; and
a data processing device,
wherein the data processing device comprises:
an acquisition unit that acquires the reception intensity data;
a first specifying unit that identifies a short-range measurement point, which is a measurement point located within a first predetermined distance from the target vehicle; and
a second specifying unit that, when the short-range measurement points satisfy a predetermined data reduction condition, identifies data corresponding to a distance within a second predetermined distance from the target vehicle, among the data indicated by the reception intensity data, as data to be analyzed.
